(19) United States
(12) Patent Application Publication
(10) Pub. No.: US 2026/0216876 A1
(43) Pub. Date: Jul. 30, 2026

(54) Intelligent Dual-Sided Library Book Retrieval and Return System and Method

(71) Applicant: Macau Millennium College, Songyusheng Square (MO)

(72) Inventors: Zehan Tan, Songyusheng Square (MO); Henghua Shen, Songyusheng Square (MO); Weihe Zhong, Songyusheng Square (MO); Yanchao Yang, Songyusheng Square (MO); Xinxin Yang, Songyusheng Square (MO); Haigang Luo, Songyusheng Square (MO); Qiu Wei, Songyusheng Square (MO)

(21) Appl. No.: 19/454,893

(22) Filed: Jan. 21, 2026

(30) Foreign Application Priority Data
Jan. 24, 2025 (CN) 2025101170084

(51) Int. Cl. B25J 9/16; B65G 1/137; G06Q 50/10

(52) U.S. Cl. CPC B25J 9/1682; B25J 9/1664; B65G 1/1371; G06Q 50/10

(57) ABSTRACT

The invention discloses an intelligent dual-sided library book retrieval and return system and method. The system comprises a double-sided bookshelf unit with one side designated for robotic operations and the opposite side for manual operations, a multi-level spatial coding positioning system for precise tray location, a vertical partitioning and retrieval slot interaction unit dividing the bookshelf into manual and robotic areas, and a robotic clamping mechanism for handling standardized book trays. The invention improves safety, accuracy, and efficiency in automated library management, particularly for high-shelf book retrieval.

### FIELD OF THE INVENTION

The present invention relates to the field of library automation and artificial intelligence technologies, and more particularly to an intelligent dual-sided library book retrieval and return system and method.

### BACKGROUND OF THE INVENTION

In existing library automation systems, robots are widely employed for book picking and placing operations. These systems typically consist of the following components:
Automated Book Retrieval and Return Robots: Equipped with mechanical arms, gripping devices, and visual recognition systems, these robots are capable of identifying and grasping specified books through visual technology. They navigate within the library using predefined paths or by first constructing a map and then employing SLAM (Simultaneous Localization and Mapping) navigation to complete book picking and placing tasks.
Bookshelves Units: The bookshelves are typically designed with a single-sided configuration, allowing robots or human operators to access them from the same side. The height of these shelves is generally around 2 meters, posing difficulties for book picking and placing operations beyond this height. The shelves feature a specialized structure aligned in the same direction as the forward movement of the trolley. The book picking and placing mechanism utilizes a combination of guide rails to achieve vertical, horizontal, and forward-backward movements. The end of the mechanism consists of a composite mechanical arm made up of book-supporting arms and book-retrieving arms, capable of extending, spreading apart, and clamping. Book picking and placing are accomplished based on camera imaging and computer control.
Positioning Systems: Robots rely on ground markers, QR codes, or RFID tags for navigation and positioning. These markers are typically placed on the ground or bookshelves to assist robots in determining their own positions and the locations of target books. Robots achieve active navigation based on the library map and their own positions, facilitating direct travel to the bookshelves where the books are located. Alternatively, RFID book positioning technology can be adopted, which is advanced and accurate but comes with significant costs. Moreover, the workload of replacing all electronic tags in a library collection is substantial, leading to the adoption of RFID electronic tags by only a few libraries currently.

In existing library automation systems, robots face several major challenges when performing book picking and placing operations:
Safety Hazards: When robots and personnel operate in the same space without proper spatial isolation, safety accidents may still occur. For instance, if a reader moves quickly or suddenly appears on the robot operational path while the robot is executing a task, a collision between the robot and the reader or staff member may occur, resulting in personal injury or equipment damage.
Low Visual Positioning Accuracy: Existing visual positioning systems suffer from accuracy issues in book localization. Factors such as damaged or worn book surfaces, similar book titles, artistic fonts used in book titles, insufficient ambient lighting, or overexposure can all affect the accuracy of the visual system. These issues may lead the robot to pick the wrong book due to positioning errors or fail to accurately return the book to its designated location, compromising the accuracy of library management.
Difficulties in High-Altitude Book Retrieval and Return: For bookshelves exceeding 2 meters in height, both robots and human operators encounter difficulties in book picking and placing operations, with manual operations posing safety risks. Retrieving books from high places requires the use of ladders or other auxiliary tools, increasing operational complexity and safety hazards.

### SUMMARY OF THE INVENTION

Therefore, the present invention provides an intelligent dual-sided book retrieval and return system and method for libraries.

An intelligent dual-sided book retrieval and return system for libraries, comprising: a double-sided bookshelf unit with a robot operation area and a manual operation area; a multi-level spatial coding positioning system utilizing Z-zone, Y-layer, and X-position codes to uniquely locate each book tray; a vertical partitioning and retrieval slot interaction unit dividing the bookshelf into an upper robotic area and a lower manual area; and a robotic book tray clamping mechanism with dual arms for securing standardized book trays and performing retrieval and return operations based on QR code alignment.

Preferably, wherein the multi-level spatial coding positioning system includes: Z-zone codes corresponding to ground positioning codes; Y-layer codes corresponding to shelf-layer identifiers; X-position codes corresponding to tray identifiers, wherein the combination of Z, Y, and X uniquely defines position of each book.

Preferably, wherein the vertical partitioning unit comprises: a lower manual operation area spanning from 0 mm to 2160 mm in height; an upper robotic operation area spanning from 2160 mm to 5200 mm in height.

Preferably, further comprising retrieval and return slots equipped with QR codes for robotic alignment, an ergonomic access plane positioned from 700 mm to 1000 mm in height above the floor, and a touch screen computer running library management software.

Preferably, wherein the retrieval and return slots further include a guide rail system configured to direct robotic delivery of trays to the slot position.

Preferably, wherein the robotic book tray clamping mechanism operates by: recognizing a ground positioning QR code, rotating 90 degrees toward the shelf; recognizing a shelf-layer positioning QR code and a tray QR code; aligning with the tray, opening clamping arms, inserting them into tray recesses, and applying clamping force; retracting and rotating to continue navigation.

Preferably, A book retrieval method for an intelligent dual-sided library book retrieval and return system, comprising the following steps:
S1. A reader inputs borrowing information at a terminal located at a delivery port;
S2. The library borrowing and returning system guides a robot to the target location via a multi-level spatial coding positioning system;
S3. The robot retrieves the corresponding book bin and transports it to the delivery port;
S4. The reader takes the book from the bin.

Preferably, A book return method for an intelligent dual-sided library book retrieval and return system, comprising the following steps:
S1. A reader inputs return information at a terminal located at a delivery port;
S2. The library borrowing and returning system instructs a robot to transport an empty book bin to the delivery port;
S3. The reader places the returned book into the bin;
S4. The robot returns the bin to its original position via the multi-level spatial coding positioning system.

Preferably, wherein the robotic operation area includes seven shelf layers with 350 mm spacing, each equipped with Data Matrix positioning identifiers, and further includes an electromagnetic safety door, warning indicators, and monitoring devices.

Preferably, wherein each tray includes a unique QR code binding the tray and its assigned book, with tray dimensions of 300 mm×300 mm×200 mm and a maximum load capacity of 30 kg, and wherein a centering base is provided to stabilize the book position.

The invention employs a double-sided bookshelf unit in which one side is designated as a robotic operation area and the opposite side as a manual operation area, ensuring physical separation of workflows. A multi-level spatial coding positioning system, based on ground positioning codes, shelf-layer positioning codes, and book tray positioning codes, enables precise location of each book.

The system further includes a vertical partitioning and retrieval slot interaction unit, dividing the bookshelf into a lower manual operation area and an upper robotic operation area. The robot is equipped with dual clamping arms for securely handling standardized book trays, with QR codes used for navigation and alignment.

This configuration reduces safety risks, increases positioning accuracy, and improves efficiency in library automation systems, particularly for handling books on high shelves.

### BRIEF DESCRIPTION OF THE DRAWINGS

FIG. 1: Overall schematic layout of the system.

FIG. 2: Diagram of the multi-level spatial coding positioning system.

FIG. 3: Book tray illustration within the spatial coding system.

FIG. 4: First schematic of vertical partitioning and retrieval slot interaction unit.

FIG. 5: Second schematic of vertical partitioning and retrieval slot interaction unit.

FIG. 6: Robotic book tray clamping mechanism design.

### DETAILED DESCRIPTION OF PREFERRED EMBODIMENTS

### Example Implementation 1

This example implementation provides a detailed description of a specific implementation method for an intelligent dual-sided library book retrieval and return system and method, encompassing the overall system architecture, functional realization of each unit, and the book retrieval and return processes.

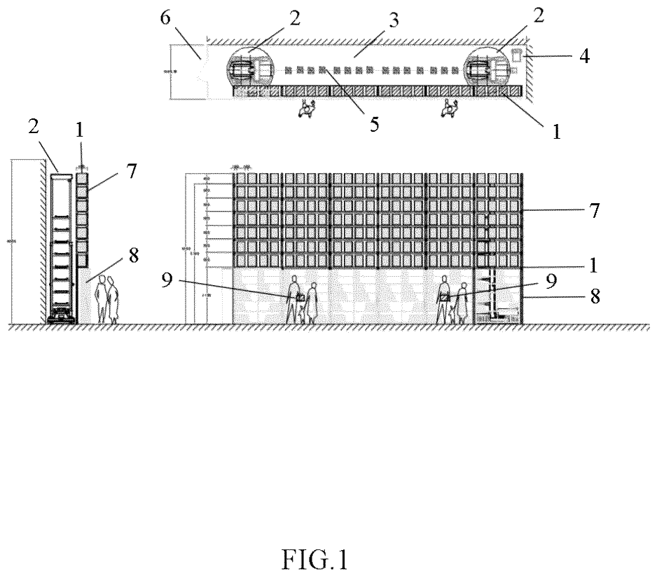

As illustrated in FIGS. 1-6, the overall system architecture includes:

The Overall Dual-Sided Bookshelf Unit Design: a) The bookshelf is divided into two vertical sections: a lower manual operation area 8 (0-2160 mm) for book retrieval and return by personnel, and an upper robotic operation area 7 (2160-5200 mm) for book retrieval and return by robots 2. The dual-sided bookshelf unit employs a layered design with a total height of 5200 mm. The lower manual operation area adopts a standard bookshelf design, facing the open area of the library. b) One side of the bookshelf serves as the robotic work area, while the opposite side is designated for the borrowers' manual operations. This design ensures that robots and personnel operate in separate areas, preventing mutual interference. c) The main framework is constructed from Q235 steel to ensure structural stability. The shelves are made of 25 mm-thick high-density fiberboard, with each layer capable of bearing a load of no less than 100 kg. d) The upper robotic operation area features seven standard shelving units with a layer spacing of 350 mm to accommodate the dimensions of book trays 12, with each layer equipped with Data Matrix (DM) code positioning markers. e) In terms of safety, the robotic work area is equipped with sensors, emergency stop buttons, and surveillance cameras; on the right side of the robotic work area, a safety protection door 6 with an electromagnetic lock is installed, accompanied by conspicuous warning signs and lights; the manual work area is treated with anti-slip flooring and installed with emergency lighting systems. f) The retrieval and return slot 9 (including a computer) facilitate human-machine interaction for book retrieval and return processes. By employing a dual-sided bookshelf design, this invention physically isolates the robotic work area from the manual work area. This physical isolation significantly reduces the risk of collisions between robots and readers or staff, enhancing the safety of the library automation system. Robots are responsible for book retrieval and return operations in the elevated areas, avoiding overlap with manual operation areas and eliminating safety hazards associated with manual book handling. Therefore, this invention represents a significant improvement in safety over existing technologies.

Multi-Level Spatial Coding Positioning System: Through the aforementioned positioning QR codes, the system implements multi-level spatial coding for the locations of books, as detailed below:
Z-Zone Coding: Corresponds to the positioning QR code 5, identifying the region where Robot 2 is located.
Y-Layer Coding: Corresponds to the bookshelf layer positioning QR code 10, indicating the specific layer number of the bookshelf.
X-Position Coding: Corresponds to the book tray positioning QR code 11, marking the position of the trays on that layer.

Thus, the combined coding of Z-Zone, Y-Layer, and X-Position uniquely determines the specific location of each book. Each book tray 12 corresponds to one book 13, with a unique QR code placed on the exterior of each book tray 12 to identify and locate the book 13 and the trays. The tray dimensions are 300×300×200 mm, with a maximum full-load weight of 30 kg, which can accommodate the sizes and weights of most books. A holder is set at the bottom of the tray to ensure the book stays centered, preventing it from falling and facilitating easy placement of books into the trays.

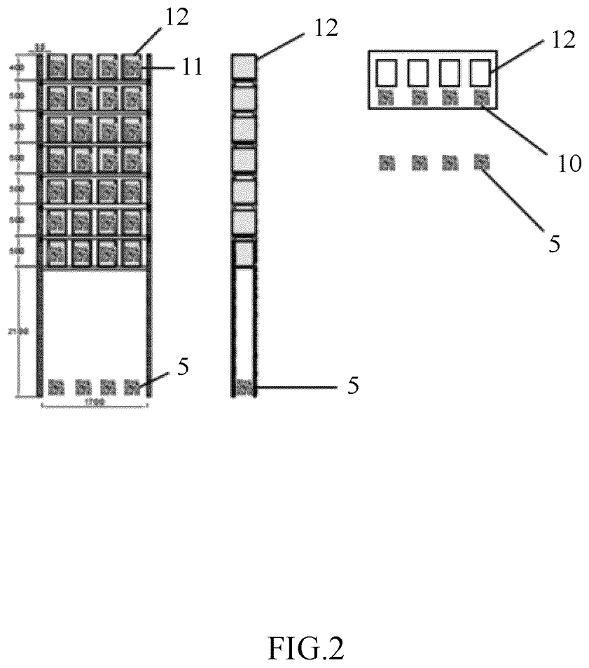

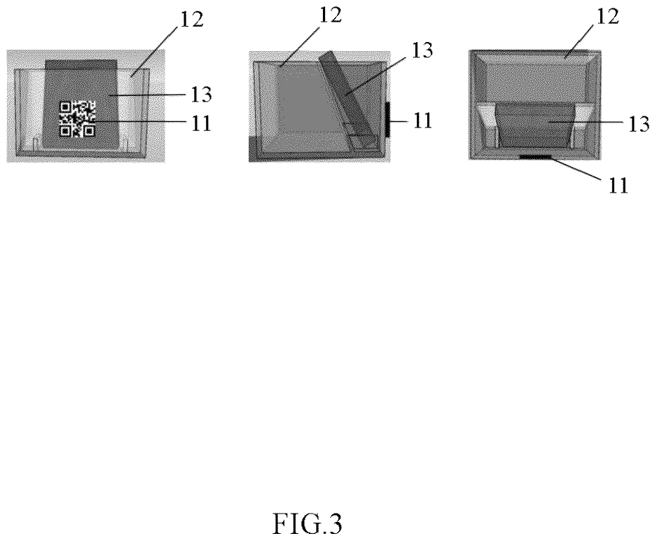

Referring to FIGS. 2 and 3, the book trays 12 positioning code (X-Position) in this invention is a QR code identifier placed on the exterior of the book trays, used to mark the specific storage location of the book. The bookshelf layer positioning code (Y-Layer) is a QR code identifier placed on each layer of the bookshelf to mark the specific layer. The ground positioning code (Z-Zone) is a QR code identifier placed on the ground to mark the region where Robot 2 should be located. The multi-level spatial coding positioning system can precisely locate each book position through these three types of positioning codes (combined coding of Z-Zone, Y-Layer, and X-Position), ensuring that Robot 2 can accurately and swiftly complete book retrieval and return operations. By adopting the “multi-level spatial coding positioning system,” this invention, in conjunction with tray positioning QR code 11, bookshelf layer positioning QR code 10, and ground positioning QR code 5, provides precise location information for each book. This positioning method does not rely on complex visual systems but instead utilizes multiple levels of QR code identifiers, ensuring accurate positioning of each book under various environmental conditions (such as poor lighting or damaged book surfaces).

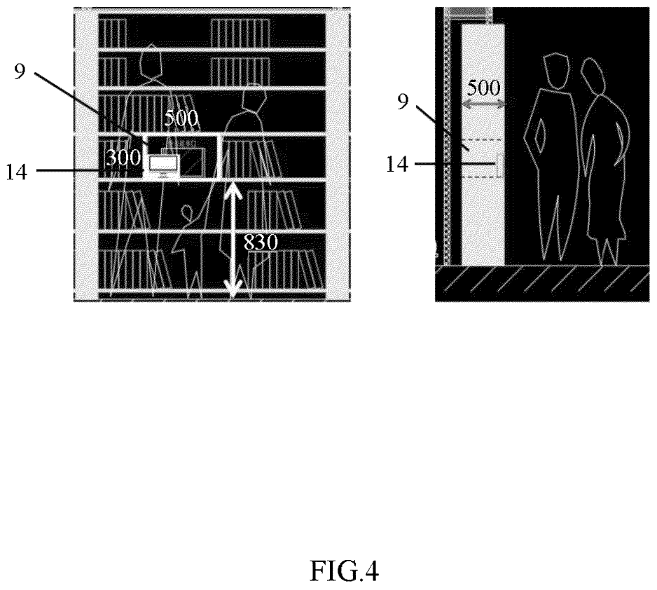

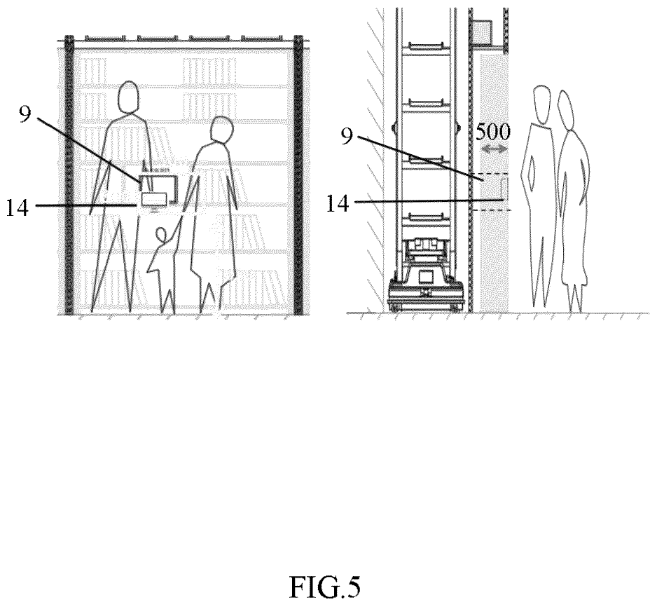

Vertical Partitioning and Retrieval Slot 9 Interaction Unit Design: As shown in FIGS. 4 and 5, this invention vertically distinguishes the bookcase by employing a vertical partitioning and retrieval slot 9 interaction unit, dividing the bookshelf into two vertical regions: a lower manual operation area 8 (0-2160 mm) for direct book retrieval by readers, and an upper robotic operation area 7 (2160-5200 mm) where robot 2 is responsible for the retrieval and placement of books at higher levels. The retrieval and return slot 9 are positioned at an appropriate location on the bookshelf for book borrowing and returning operations by readers. Sufficient space is reserved at the retrieval and return slot 9 for robot 2 to place and retrieve book trays 12, with a recommended depth of ≥500 mm. The design of the retrieval and return slot 9 considers adequate height and width: 500 mm (depth)*300 mm (height)*500 mm (width) to ensure smooth placement and retrieval of book trays 12 by robot 2. A retrieval and return QR code are placed at the retrieval and return slot 9 to facilitate accurate positioning by robot 2 for book trays 12 retrieval and return actions. The distance from the plane where goods are placed at the slot to the ground is recommended to be between 700 mm and 1000 mm, facilitating easy access for readers and staff (illustrated as 830 mm).

### Components of the Retrieval and Return Slot 9 Interaction Unit Design:

Retrieval and Return Slot 9: Positioned appropriately on the bookshelf, it allows readers to perform book borrowing and returning operations.
Slot Guide Rail System: Guides robot 2 to accurately transport the book trays 12 to the slot position.
Touch Screen Computer 14 at the Slot: Equipped with a library borrowing and returning system for easy management and operation.

### Book Borrowing Method:

Step 1. The reader inputs borrowing information at the terminal of the retrieval and return slot.
Step 2. The library borrowing and returning system guides robot 2 to the target location via the multi-level spatial coding positioning system.
Step 3. Robot 2 retrieves the corresponding book trays 12 and transports it to the retrieval and return slot.
Step 4. The reader takes the book 13 from the book trays.

### Book Returning Method:

Step 1. The reader inputs returning information at the terminal of the retrieval and return slot.
Step 2. The library borrowing and returning system instructs robot 2 to transport the empty book trays 12 to the retrieval and return slot.
Step 3. The reader places the returned book 13 into the book trays.
Step 4. Robot 2 returns the book trays 12 to its original position using the multi-level spatial coding system.

Through the “vertical partitioning design,” this invention logically divides the bookshelf area into two sections: the lower area 8 serves as the manual book borrowing and returning zone, suitable for daily book borrowing and returning activities; the upper area 7 functions as the robot 2 book borrowing and returning zone, specifically designated for robot 2 handling of books in elevated areas. Robot 2 is responsible for book retrieval operations in elevated areas, eliminating the safety hazards associated with manual operations that require ladders or other auxiliary tools.

This vertical partitioning design prevents overlap between manual and robot 2 work areas, enhancing operational safety and efficiency.

Furthermore, when robot 2 operates in elevated areas, its adoption of a high-precision positioning system enables efficient book picking and placing tasks, reducing safety risks during manual book retrieval and improving library operational efficiency.

Compared to existing technologies, this design ensures operational safety in elevated areas and lowers the incidence of human-caused accidents.

### Robot 2 Clamping Book Tray 12 Design:

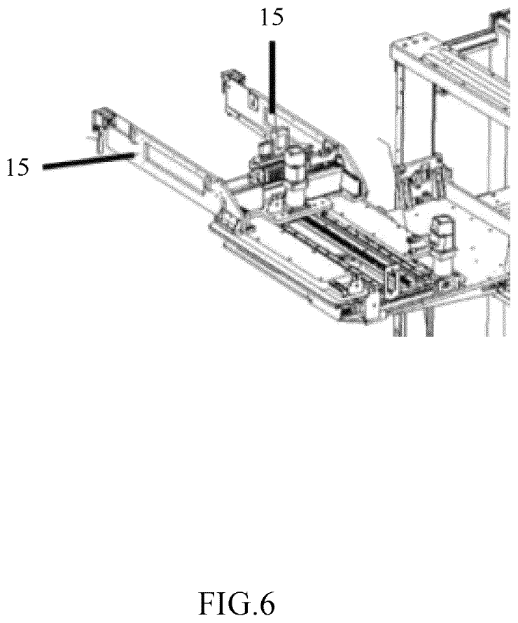

As shown in FIG. 6, robot 2 clamps the book trays of fixed dimensions using two designed mechanical gripping arm 15. These two mechanical gripping arms

15 can bear a weight of 30 kg, ensuring the trays are securely locked. When robot 2 identifies the ground positioning QR code, it rotates 90 degrees to face the bookshelf, then recognizes the corresponding shelf-layer positioning QR code 10, followed by the tray QR code.

After locating the correct tray QR code, robot 2 adjusts its posture to face the trays directly. The two gripping arms then open to 400 mm, move forward a fixed distance to insert the mechanical arms on both sides of a tray, and then the mechanical arms move inward by 10 mm via a motor to lock the trays. Robot 2 then moves backward a fixed distance, rotates 90 degrees, and searches for the next ground positioning QR code, such as the one corresponding to the retrieval and return slot 9, to perform book borrowing and returning operations.

Through the “retrieval and return slot 9 interaction unit design,” this invention achieves seamless integration between manual and robot 2 work processes.

During the book borrowing process, the reader inputs borrowing information via the computer at the slot, and the system guides robot 2 to the target location using multi-level spatial coding positioning technology, ensuring robot 2 accurately locates the target book tray and delivers it to the slot area for the reader to retrieve. During the book returning process, after the reader inputs returning information, the system instructs robot 2 to deliver the empty book tray 12 to the slot area. After the reader places the books in the tray, robot 2 returns the tray to its original position.

This design not only optimizes the collaboration process between humans and robot 2 but also enhances work efficiency. Readers can perform book borrowing and returning operations more conveniently, while robot 2 ensures accurate and efficient operations through its precise positioning system, further elevating the library automation level.

Through the aforementioned technical solutions, this invention surpasses existing technologies in several aspects:
Safety: The dual-sided bookshelf design effectively isolates manual and robot 2 work areas, avoiding safety hazards.
Positioning Accuracy: The multi-level spatial coding positioning system significantly enhances book positioning accuracy.
Elevated Operations: Vertical partitioning design resolves safety and efficiency issues associated with elevated book retrieval.
Human-Robot Collaboration: Through well-designed interaction units, the book borrowing and returning process is optimized, improving overall efficiency.

Therefore, this invention demonstrates significant technical advantages in enhancing the safety, accuracy, and efficiency of library automation systems.

### Example Implementation 2

This example builds upon Example 1 and includes optimizations primarily in the following aspects:

### Alternative Solution for Dual-Sided Bookshelf Design:

Virtual Isolation: Virtual isolation is achieved by setting up ground sensors and virtual zones. Robot 2 can only operate within specific virtual boundaries. When robot 2 approaches the manual operation area, the sensors trigger an alarm and automatically shut down the robot.

This alternative solution provides a flexible spatial isolation method in various environments, ensuring the safety of robot 2 and manual operations under reliable sensor conditions. Although the dual-sided bookshelf design is currently the optimal solution, this alternative can still effectively prevent accidents to a certain extent and enhance system safety.

### Alternative Solutions for Multi-Level Spatial Coding Positioning System:

RFID Technology: Radio Frequency Identification (RFID) technology can be used as an alternative. Each book, bookshelf, and tray are equipped with RFID tags, and the book location is precisely determined through readers. This approach does not rely on visual positioning or multi-level coding identifiers and offers high resistance to interference. However, it incurs higher costs due to the manual installation of RFID tags on each book and has a longer implementation period.

Machine Vision and Deep Learning: By combining deep learning algorithms with high-resolution machine vision systems, environmental images can be captured through cameras, and book locations can be identified through image recognition technology. However, in complex environments, the visual system struggles to adapt flexibly to varying lighting conditions.

These alternative solutions offer different technical means to achieve book positioning. RFID can enhance positioning accuracy and reduce environmental impacts, while machine vision and deep learning can improve system flexibility. However, they have high lighting requirements and demands on the book's surface quality, as they cannot tolerate wear-induced blurriness or recognize book titles in artistic fonts. These alternatives may be more suitable in specific scenarios, such as special environments or cost considerations.

### Alternative Solution for Vertical Partitioning Design:

Adjustable Bookshelf Height Design: The height of the bookshelves can be adjusted using an electric lifting system, allowing different levels of the bookshelf to be automatically adjusted to heights accessible by humans or robot 2 as needed. This design reduces the requirements for the operational area of robot 2 and allows for flexible adjustment of the workspace.

This alternative solution offers a different approach to optimize bookshelf utilization. The adjustable bookshelf height design increases spatial flexibility and scalability but comes with higher costs and requirements for the load capacity and reliability of the electric lifting system.

### Alternative Solution for Retrieval and Return Slot 9 Interaction Unit:

Automatic Door System: An automatic door system can be adopted to replace the existing slot interaction unit. In this design, book trays are delivered into an automatically opening door frame by a robotic arm, and readers can open the door frame for borrowing and returning operations through simple touch or scan actions.

### Effect of Alternative Solutions:

The automatic door system simplifies manual operations and enhances convenience but increases costs.

The aforementioned alternative solutions can effectively replace each technical solution in this invention and achieve the goals of safety, accuracy, and efficiency in library automation systems under specific scenarios.

While the present invention has been described by means of specific embodiments, numerous modifications and variations could be made thereto by those skilled in the art without departing from the scope and spirit of the present invention set forth in the claims.

What is claimed is

1. An intelligent Dual-Sided Library Book Retrieval and Return System, comprising: a double-sided bookshelf unit with a robot operation area and a manual operation area; a multi-level spatial coding positioning system utilizing Z-zone, Y-layer, and X-position codes to uniquely locate each book tray; a vertical partitioning and retrieval slot interaction unit dividing the bookshelf into an upper robotic area and a lower manual area; and a robotic book tray clamping mechanism with dual arms for securing standardized book trays and performing retrieval and return operations based on QR code alignment.

2. The intelligent Dual-Sided Library Book Retrieval and Return System according to claim 1, wherein the multi-level spatial coding positioning system includes: Z-zone codes corresponding to ground positioning codes; Y-layer codes corresponding to shelf-layer identifiers; X-position codes corresponding to tray identifiers, wherein the combination of Z, Y, and X uniquely defines each book position.

3. The intelligent Dual-Sided Library Book Retrieval and Return System according to claim 1, wherein the vertical partitioning unit comprises: a lower manual operation area spanning from 0 mm to 2160 mm in height; an upper robotic operation area spanning from 2160 mm to 5200 mm in height.

4. The intelligent Dual-Sided Library Book Retrieval and Return System according to claim 1, further comprising retrieval and return slots equipped with QR codes for robotic alignment, an ergonomic access plane positioned from 700 mm to 1000 mm in height above the floor, and a touch screen computer running library management software.

5. The intelligent Dual-Sided Library Book Retrieval and Return System according to claim 4, wherein the retrieval and return slots further include a guide rail system configured to direct robotic delivery of trays to the slot position.

6. The intelligent Dual-Sided Library Book Retrieval and Return System according to claim 1, wherein the robotic book tray clamping mechanism operates by: recognizing a ground positioning QR code, rotating 90 degrees toward the shelf; recognizing a shelf-layer positioning QR code and a tray QR code; aligning with the tray, opening clamping arms, inserting them into tray recesses, and applying clamping force; retracting and rotating to continue navigation.

7. A book retrieval method for an intelligent dual-sided library book retrieval and return system, comprising the following steps:
Step 1. A reader inputs borrowing information at a terminal located at a delivery port;
Step 2. The library borrowing and returning system guides a robot to the target location via a multi-level spatial coding positioning system;
Step 3. The robot retrieves the corresponding book bin and transports it to the delivery port;
Step 4. The reader takes the book from the bin.

8. A book return method for an intelligent dual-sided library book retrieval and return system, comprising the following steps:
Step 1. A reader inputs return information at a terminal located at a delivery port;
Step 2. The library borrowing and returning system instructs a robot to transport an empty book bin to the delivery port;
Step 3. The reader places the returned book into the bin;
Step 4. The robot returns the bin to its original position via the multi-level spatial coding positioning system.

9. The intelligent Dual-Sided Library Book Retrieval and Return System according to claim 1, wherein the robotic operation area includes seven shelf layers with 350 mm spacing, each equipped with Data Matrix positioning identifiers, and further includes an electromagnetic safety door, warning indicators, and monitoring devices.

10. The intelligent Dual-Sided Library Book Retrieval and Return System according to claim 2, wherein each tray includes a unique QR code binding the tray and its assigned book, with tray dimensions of 300 mm×300 mm×200 mm and a maximum load capacity of 30 kg, and wherein a centering base is provided to stabilize the book position.
